(19) United States
(12) Patent Application Publication
(10) Pub. No.: US 2009/0049514 A1
(43) Pub. Date: Feb. 19, 2009

(54) Autonomic trust management for a trustworthy system

(75) Inventors: Zheng Yan, Espoo (FI); Christian Prehofer, Espoo (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: NOKIA CORPORATION

(21) Appl. No.: 11/889,600

(22) Filed: Aug. 15, 2007

(51) Int. Cl. G06F 21/00; G06F 17/00; H04L 9/00

(52) U.S. Cl. 726/1; 726/25; 726/6

(57) ABSTRACT

An autonomic trust management system, device or method performs trust management in an autonomic processing manner with regard to evidence collection, trust evaluation, and trust (re-)establishment and control. An autonomic trust management mechanism is embedded into a digital system, such as a device or a distributed system, for supporting trustworthy relationships among system entities. The trust management mechanism provides an autonomic adaptation of trust control modes, which include control mechanisms or operations, in order to ensure the dynamic changed trust relationships based on the feedback from a trust assessment and the adaptive trust (re-)establishment or control loops.

### BACKGROUND OF THE INVENTION

1. Field of the Invention

The present invention relates to an autonomic trust management mechanism, system, or method that can be embedded into a digital system to support trustworthy relationships among various system entities, and more particularly, an autonomic trust management mechanism, system, or method providing an autonomic trust management solution in an autonomic processing manner with respect to evidence collection, trust evaluation, and trust (re-)establishment and control.

2. Description of the Related Art

The concept of trust has been studied in disciplines ranging from economic to psychology, from sociology to medicine, and to information science. It is hard to define what trust exactly is because it is a multidimensional, multidiscipline and multifaceted concept. Various definitions of trust may be found in literature. Common to these definitions are the notions of confidence, belief, faith, hope, expectation, dependence, and reliance on the goodness, strength, reliability, integrity, ability, or character of a person or thing.

Generally, a trust relationship involves two parties: a trustor and a trustee. The trustor is the person or entity who holds confidence, belief, faith, hope, expectation, dependence, and reliance on the goodness, strength, reliability, integrity, ability, or character of another person or thing, which is the object of trust—the trustee.

Trust management is concerned with collecting the information required to make a trust relationship decision; evaluating the criteria related to the trust relationship as well as monitoring and re-evaluating existing trust relationships; and automating the process. An extension of this definition is needed in order to manage trust in a digital system (for instance, a computing platform) in an autonomic way. Autonomic trust management automatically processes evidence collection, trust evaluation, and trust (re-)establishment and control.

Trust evaluation is a technical approach of representing trustworthiness for digital processing, in which the factors influencing trust will be evaluated by a continuous or discrete real number, referred to as a trust value. Embedding a trust evaluation mechanism into trust management is necessary for providing trust intelligence in future digital systems.

In accordance with an embodiment of the present invention, trust is considered from a system point of view. Trust is the assessment of a trustor on how well the observed behavior of a trustee (that can be reflected by a number of the trustee's quality attributes) meets the trustor's own standards for an intended purpose.

Trust management is an important factor related to decision making, for instance, for electronic commerce, Internet interactions, and electronic contract negotiation. Therefore, trust plays an important role in a digital system, especially when a system is component based and varies due to component joining and leaving. How to manage trust in such a system is crucial for a device, such as a mobile device. Recently, many mechanisms and methodologies have been developed to support trustworthy communications and collaborations in distributed systems and e-commerce systems (for instance, Ad Hoc Networks, Peer-to-Peer (P2P) systems, GRID computing systems, and e-transactions). These methodologies are based on digital modeling of trust for trust evaluation and management. Most of existing solutions focus on the evaluation of trust, but lack a proposal regarding how to manage, that is, ensure or control, trust based on the evaluation result. Most of existing solutions generally do not consider the influence of trust control mechanisms on trustworthiness. Typically, these methodologies are not feasible for automatically supporting a digital system's or a communication system's trustworthiness (e.g. a device software platform). Due to the amount of data collected and processed in the digital environment, the existing definition of trust management needs to be extended to accommodate support for automatic processing in order to provide a system's trustworthiness.

Presently, trust evaluation is used for simple decisions, such as selecting a most trustworthy node in ad hoc networks. However, in many situations, it is hard for the trustor (or the system) to decide how to manage the existing trust relationship on the basis of some digital number, such as a trust value.

A number of trusted computing and management projects and studies have been conducted in the literature and industry, which mostly focus on some specific aspects of trust. For example, TCG (Trusted Computing Group) aims to build up a trusted computing device on the basis of a secure hardware chip focusing on ensuring a computing platform's security and the platform user's privacy. Some of trust management systems focus on protocols for establishing trust in a particular context, generally related to security requirements. Others make use of a trust policy language to allow the trustor to specify the criteria for a trustee to be considered trustworthy. However, the focus on the security aspect of trust tends to assume that other non-functional requirements, such as availability and reliability, have already been addressed. Focusing on security may influence other aspects of trust, such as availability. In addition, TCG based trusted computing solution can not handle the runtime trust management issues of a component software system.

Accordingly, in view of the above, an autonomic trust management solution is needed that may be embedded into a digital system to support the trustworthy relationships among various system entities. The autonomic trust management solution would allow management of trust automatically according to trust evaluation results.

### SUMMARY OF THE INVENTION

In accordance with an embodiment of the present invention, there is provided a trust management method, including determining at a trust management framework whether a system comprises a competence to manage a trustee, wherein the competence comprises at least one trust control mode supported by the system to ensure a trustworthiness of the trustee, and based on the competence, generating a number of different trust control modes at the trust management framework to be applied by the system to manage the trustworthiness of the trustee and to provide an autonomic adaptation of the applied trust control modes to ensure a dynamic changed trust relationship. The method also includes, based on the trust control modes generated, generating and adjusting at the trust management framework at least one trust control model profile associated with a trustor and the trustee to perform autonomic trust management.

A trust control mode contains a number of control mechanisms and/or operations, e.g. encryption, authentication, hash code based integrity check, access control mechanisms, duplication of process, man-in-middle solution for improving availability, etc. The trust control mode can be treated as a special configuration of trust management that can be provided by the system.

In accordance with an embodiment of the present invention, there is provided a trust management method. The method includes receiving a trustee identity and trust criteria regarding a trustee from a trustor at a trust management framework, and determining at the trust management framework whether a system comprises a competence to manage the trustee. The method also includes transmitting a response from the system to the trust management framework confirming the competence of the system to manage the trustee. Based on the competence, the method generates a number of different trust control modes at the trust management framework to be applied by the system to manage a trustworthiness of the trustee, and based on the trust control modes generated, creating at the trust management framework a trust control model profile associated with the trustor and the trustee to perform autonomic trust management.

In accordance with an embodiment of the present invention, there is provided a trust management method, including predicting a trustworthiness of a trustee specified by a trustor at a trust management framework by testing different trust control modes on the trustee and outputting prediction results indicative thereof, selecting a set of trust control modes by the trust management framework with an optimal trust value and optimal quality attribute values to manage the trustworthiness of the trustee based on the prediction results, determining whether a system includes a trust control mode corresponding to the selected trust control mode, and applying at the trustee the determined trust control mode by the system. The method also includes monitoring through the trust management framework a behavior of the trustee in real time to collect data, executing through the trust management framework a trust assessment based on the collected data, when the trust assessment is positive, continuing the monitoring of the behavior of the trustee, and when the trust assessment is negative, adjusting through the trust management framework a trust control model profile associated with the trustor and the trustee to perform autonomic trust management.

In accordance with an embodiment of the present invention, there is provided a device for trust management, including a determining unit configured to determine whether a system comprises a competence to manage a trustee, wherein the competence comprises at least one trust control mode supported by the system to ensure a trustworthiness of the trustee. The device also includes a generating unit configured to generate, based on the competence, a number of different trust control modes at the trust management framework to be applied by the system to manage a trustworthiness of the trustee and to provide an autonomic adaptation of the applied trust control modes to ensure a dynamic changed trust relationship, and based on the trust control modes generated, configured to generate and adjust at the trust management framework at least one trust control model profile associated with the trustor and the trustee to perform autonomic trust management.

In accordance with an embodiment of the present invention, there is provided a device, including a processing unit configured to receive a request from a trustor to register the trustor at a trust management framework in a system, perform a verification of an identification of the trustor, transmit a request acknowledgement to the trustor after verifying the trustor, receive a trustee identity and trust criteria regarding a trustee from the trustor, and determine whether the system comprises a competence to manage the trustee, a receiving unit configured to receive a confirmation from the system confirming the competence of the system to manage the trustee. The device also includes a generation unit configured to generate, based on the competence, a number of different trust control modes at the trust management framework to be applied by the system to manage a trustworthiness of the trustee, and configured to create, based on the trust control modes generated, at the trust management framework a trust control model profile associated with the trustor and the trustee to perform autonomic trust management.

In accordance with an embodiment of the present invention, there is provided a device, including a predicting unit configured to predict a trustworthiness of a trustee specified by a trustor at a trust management framework by testing different trust control modes on the trustee and outputting prediction results indicative thereof, a selecting unit configured to select a set of suitable trust control modes with an optimal trust value and optimal quality attribute values based on the prediction results, and a determining unit configured to determine whether a system includes a trust control mode corresponding to the selected trust control modes and apply at the trustee the determined trust control modes by the system. The device also includes an adaptation unit configured to monitor through the trust management framework a behavior of the trustee in real time to collect data, and to execute through the trust management framework a trust assessment based on the collected data, wherein when the trust assessment is positive, the adaptation unit is configured to continue the monitoring of the behavior of the trustee, and when the trust assessment is negative, the adaptation unit is configured to adjust through the trust management framework a trust control model profile associated with the trustor and the trustee to perform autonomic trust management.

In accordance with an embodiment of the present invention, there is provided a device for trust management, including determining means for determining whether a system comprises a competence to manage a trustee, wherein the competence comprises at least one trust control mode supported by the system to ensure a trustworthiness of the trustee. The device also includes generating means for generating, based on the competence, a number of different trust control modes at the trust management framework to be applied by the system to manage the trustworthiness of the trustee and to provide an autonomic adaptation of the applied trust control modes to ensure a dynamic changed trust relationship, and based on the trust control modes generated, generating and adjusting at the trust management framework at least one trust control model profile associated with the trustor and the trustee to perform autonomic trust management.

In accordance with an embodiment of the present invention, there is provided a device, including processing means for receiving a request from a trustor to register the trustor at a trust management framework in a system, performing a verification of an identification of the trustor, transmitting a request acknowledgement to the trustor after verifying the trustor, receiving a trustee identity and trust criteria regarding a trustee from the trustor, and determining whether the system comprises a competence to manage the trustee. The device also includes receiving means for receiving a confirmation from the system confirming the competence of the device to manage the trustee, and generation means for generating, based on the competence, a number of different trust control modes at the trust management framework to be applied by the system to manage a trustworthiness of the trustee, and for creating, based on the trust control modes generated, at the trust management framework a trust control model profile associated with the trustor and the trustee to perform autonomic trust management.

In accordance with an embodiment of the present invention, there is provided a device, including predicting unit means for predicting a trustworthiness of a trustee specified by a trustor at a trust management framework by testing different trust control modes on the trustee and outputting prediction results indicative thereof, selecting means for selecting a set of suitable trust control mode with an optimal trust value and optimal quality attribute values based on the prediction results, and determining means for determining whether a system includes a trust control mode corresponding to the selected trust control modes and apply at the trustee the determined trust control modes by the system. The device also includes adaptation means for monitoring through the trust management framework a behavior of the trustee in real time to collect data, and for executing through the trust management framework a trust assessment based on the collected data, wherein when the trust assessment is positive, the adaptation means continues the monitoring of the behavior of the trustee, and when the trust assessment is negative, the adaptation means adjusts through the trust management framework a trust control model profile associated with the trustor and the trustee to perform autonomic trust management.

In accordance with an embodiment of the present invention, there is provided an autonomic trust management system for autonomic trust management for trust management, including a determining unit configured to determine whether the system comprises a competence to manage a trustee, wherein the competence comprises at least one trust control mode supported by the system to ensure a trustworthiness of the trustee. The device also includes a generating unit configured to generate, based on the competence, a number of different trust control modes at the trust management framework to be applied by the system to manage the trustworthiness of the trustee and to provide an autonomic adaptation of the applied trust control modes to ensure a dynamic changed trust relationship, and based on the trust control modes generated, configured to generate and adjust at the trust management framework at least one trust control model profile associated with the trustor and the trustee to perform autonomic trust management.

In accordance with an embodiment of the present invention, there is provided an autonomic trust management system for autonomic trust management, including a processing unit configured to receive a request from a trustor to register the trustor at a trust management framework in the system, perform a verification of an identification of the trustor, transmit a request acknowledgement to the trustor after verifying the trustor, receive a trustee identity and trust criteria regarding a trustee from the trustor, and determine whether the system comprises a competence to manage the trustee, a receiving unit configured to receive a confirmation from the system confirming the competence of the system to manage the trustee. The system also includes a generation unit configured to generate, based on the competence, a number of different trust control modes at the trust management framework to be applied by the system to manage the trustworthiness of the trustee, and configured to create, based on the trust control modes generated, at the trust management framework a trust control model profile associated with the trustor and the trustee to perform autonomic trust management.

In accordance with an embodiment of the present invention, there is provided an autonomic trust management system for autonomic trust management, including a predicting unit configured to predict a trustworthiness of a trustee specified by a trustor at a trust management framework by testing different trust control modes on the trustee and outputting prediction results indicative thereof, a selecting unit configured to select a set of suitable trust control modes with an optimal trust value and optimal quality attribute values based on the prediction results, and a determining unit configured to determine whether the system includes a trust control mode corresponding to the selected trust control modes and apply at the trustee the selected trust control modes by the system. The device also includes an adaptation unit configured to monitor through the trust management framework a behavior of the trustee in real time to collect data, and to execute through the trust management framework a trust assessment based on the collected data, wherein when the trust assessment is positive, the adaptation unit is configured to continue the monitoring of the behavior of the trustee, and when the trust assessment is negative, the adaptation unit is configured to adjust through the trust management framework a trust control model profile associated with the trustor and the trustee to perform autonomic trust management.

### BRIEF DESCRIPTION OF THE DRAWINGS

Further embodiments, details, advantages and modifications of the present invention will become apparent from the following detailed description of the preferred embodiments which is to be taken in conjunction with the accompanying drawings, in which:

FIG. 1 illustrates a platform based trust management framework, in accordance with an embodiment of the present invention.

FIG. 2 illustrates a collaborated trust management framework, in accordance with an embodiment of the present invention.

FIG. 3A illustrates a system or device for a registration of a trustor at a trust management framework in a system, in accordance with an embodiment of the present invention.

FIG. 3B illustrates a procedure of a trustor's registration at a trust management framework, in accordance with an embodiment of the present invention.

FIGS. 4A and 4B illustrate a data structure of trust control model profile, in accordance with an embodiment of the present invention.

FIG. 5A illustrates a system or device for a trust management framework to conduct autonomic trust management in a system targeting a trustee specified by a trustor, in accordance with an embodiment of the present invention.

FIG. 5B illustrates a procedure for autonomic trust management, in accordance with an embodiment of the present invention.

### DETAILED DESCRIPTION OF THE PREFERRED EMBODIMENTS

Reference will now be made in detail to preferred embodiments of the present invention, examples of which are illustrated in the accompanying drawings. In accordance with an embodiment of the present invention, there is provided an autonomic trust management device, system or method for trust management in an autonomic processing manner with regard to evidence collection, trust evaluation, and trust (re-)establishment and control. Trust evaluation is a technical approach of representing trustworthiness for digital processing, in which factors influencing trust are evaluated by a continuous or discrete real number, referred to as a trust value. Autonomic is defined as having autonomy; not subject to control from outside; independent from human intervention or an outside element.

The growing importance of component software introduces special requirements on trust due to the nature of applications they provide; in particular, when the software system supports components joining and leaving at runtime. The system also needs to support different trust requirements from the same or different components. Trust may include several properties, such as security, availability and reliability, depending on the requirements of a trustor. Hence trust is the assessment of a trustor on how well the observed behavior (which is reflected by a number of quality attributes) of a trustee meets the trustor's own standards or criteria for an intended purpose.

In accordance with an embodiment of the present invention, a digital system, such as a software system, a distributed system, or an e-commerce system contain a number of entities, such as a service, a component (composition of components), an application, a device or an entire system. The trustworthiness of the digital system may be built upon establishing trust relationships among those entities. The trustworthiness of a system element or entity depends on a number of quality attributes of the system entity. The quality attributes can be the entity's trust properties (such as, security, availability, and reliability) and recommendations or reputations with regard to this entity. The decision or assessment of trust may be conducted based on the trustor's (such as, a system user or his/her delegate) subjective criteria and the trustee entity's quality attributes, and influenced by context information. Context may include any information that may be used to characterize the situation of the involved entities. The quality attributes of the system entities can be controlled or improved by applying a number of trust control mechanisms, while due to dynamic characteristic of current systems, the trust relationships may be changed and influenced with each other. For example, a software system may change due to software joining and leaving. A distributed system may change due to its topology change. In accordance with an embodiment of the present invention, the autonomic trust management system and method managing trust in digital or communication systems in an autonomic manner is a crucial issue.

Trust management is generally concerned with collecting the information required to make a trust relationship decision; evaluating the criteria related to the trust relationship as well as monitoring and reevaluating existing trust relationships; and automating the process. Autonomic trust management may include the following aspects:
Trust establishment: the process for establishing a trust relationship between a trustor and a trustee.
Trust monitoring: the trustor or its delegate monitors the behavior of the trustee. The monitoring process aims to collect useful evidence for trust assessment.
Trust assessment: the process for evaluating the trustworthiness of the trustee by the trustor or its delegate with respect to specified criteria. The trustor assesses the current trust relationship and decides if this relationship has changed.
Trust control and re-establishment: if the trust relationship has changed, the trustor will find reasons and make a decision if and which measures should be taken in order to control or re-establish the trust relationship. This is implemented by changing the trust control modes applied by the system.

In accordance with an embodiment of the present invention, a component software platform is provided which is composed of a number of entities, for instance, a component (composition of components), an application, a sub-system, and an entire platform system. The trustworthiness of a platform entity or trustee may depend on a number of quality attributes associated with the trustee. The quality attributes may be the trustee's trust properties, such as, security, availability, and reliability, and recommendations or reputations with regard to this entity.

Furthermore, in accordance with an embodiment of the present invention, a decision or assessment of trust may be conducted based on a trustor's subjective criteria and a trustee entity's quality attributes, and may be influenced by context information. The trustor may be a platform user or his/her delegate. Context may include any information that can be used to characterize the situation of the involved entities. The quality attributes of the platform entities may be controlled or improved by applying a number of trust control mechanisms.

An embodiment of the present invention provides an autonomic trust management mechanism that may be embedded into a device, a digital system, or a communication system for supporting trustworthy relationships among system entities. The autonomic trust management mechanism may provide autonomic adaptation of trust control modes, which may include control mechanisms or operations, based on the feedback from a trust assessment and the adaptive trust (re-)establishment or control loops.

In accordance with an embodiment of the present invention, the autonomic trust management mechanism or methodology conducts autonomic trust management in the system targeting at a trustee entity specified by a trustor entity. The system may include the autonomic trust management mechanism in a trust management framework embedded in a device to manage trust of various system entities. The trust management framework may adopt a number of mechanisms for autonomic trust management purposes. These mechanisms may include, but are not limited to, a trustworthiness prediction, a trust control mode selection, a trust assessment, and a trust control model adjustment. A trust control mode includes a number of control mechanisms and/or operations, such as, encryption, authentication, hash code based integrity check, access control mechanisms, duplication of process, man-in-middle solution for improving availability, etc. The trust control mode may be treated as a special configuration of trust management that can be provided by the system. A person of ordinary skill in the art will appreciate that other types of control mechanisms and/or operations may be further implemented in the trust control mode. A trust control model is a profile associated with the trustor and the trustee and is used to express trust related factors, such as, trustworthiness of trustee, trustee's quality attributes and corresponding importance rates, and system offered control modes (that is, the system's capability or competence) and corresponding influencing rates to the different quality attributes.

In accordance with an embodiment of the present invention, for a registered trustor at the trust management framework, the trustworthiness prediction may be performed in which the trustworthiness of an associated specified trustee may be predicted regarding various control modes supported by the system and output prediction results indicative thereof. The trustworthiness prediction is a mechanism to anticipate the performance or feasibility of applying some trust control modes before taking a concrete action. The trustworthiness prediction is generally conducted to predict the trust value supposed that some control modes are applied before making the decision to initiate those mechanisms. Based on the prediction results, the trust control mode selection is performed in which a suitable set of control modes may be selected to establish the trust relationship between the trustor and the trustee. The trust control mode selection is a mechanism to select the most suitable trust control modes based on the prediction results in order to manage trust.

Furthermore, the trust assessment mechanism may be triggered to evaluate the trustworthiness of the trustee through monitoring of the trustee's behavior based on an instruction of the trustor's criteria. A trust assessment result may be generated as a result of the evaluation of the trustworthiness of the trustee. The trust assessment is a mechanism to evaluate or re-evaluate the trustworthiness based on observation on the trustee's quality attributes.

According to the trust assessment results, the system may conduct a trust control model adjustment in order to reflect a real system context and situation if the trust assessment result is negative (for instance, under a threshold). The adaptive adjustment of the trust control model is a mechanism to update parameters in the trust control model in order to make it match real system context or situation.

In accordance with an illustrative embodiment, a negative result of the trust assessment may be generated based on a threshold. In one embodiment, the threshold may be set by the trustor to express the trustor's expectation of the trust assessment. In accordance with an embodiment of the present invention, the system may repeat the trustworthiness prediction, the control mode selection, and the trust assessment, and an adaptive adjustment of the trust control model when needed. Context-aware or situation-aware adaptability of the trust control model is crucial to re-select suitable control modes for the system to conduct autonomic trust management.

The digital system is composed of a number of entities. These entities can be any parties that are involved into or related to the system. They can be related with each other in order to provide some services or functionalities or they can cooperate with each other in order to fulfill an intended purpose. The trust relationship is required to build among those entities in order to provide a trustworthy system.

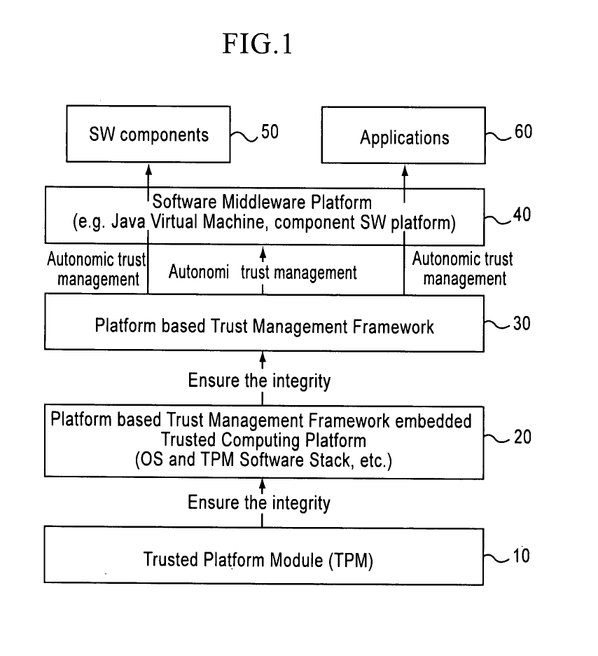

In accordance with an embodiment of the present invention, a trust management framework in a device, a digital system, or a communication system is shown in FIG. 1. There may be at least two kinds of implementation based on the types of the system. A first kind of implementation is a platform based trust management framework. The platform based trust management framework may be protected by the trusted computing technology or embedded functionality of the TPM based trusted computing platform, as shown in FIG. 1. FIG. 1 illustrates the platform based trust management framework, in accordance with an embodiment of the present invention. The implementation of the platform based trust management framework illustrated in FIG. 1 may be suitable for a system such as a software platform, a device, or a device application. The communications among the system entities are inside the device or the platform. In this case, both the trustor and trustee may be located in the same device.

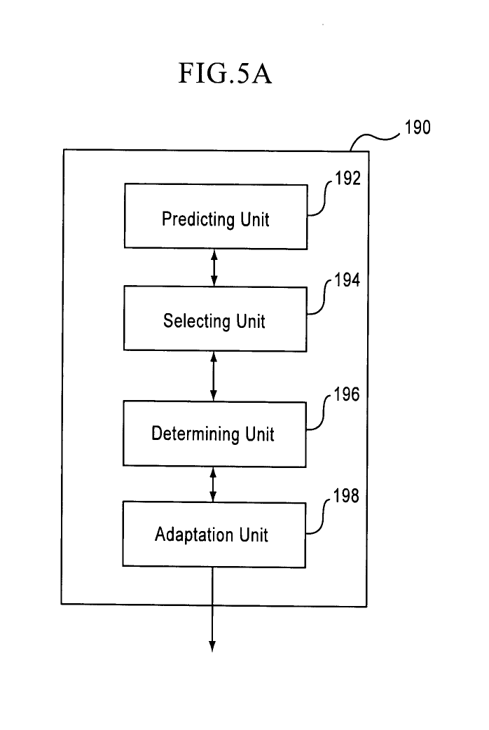

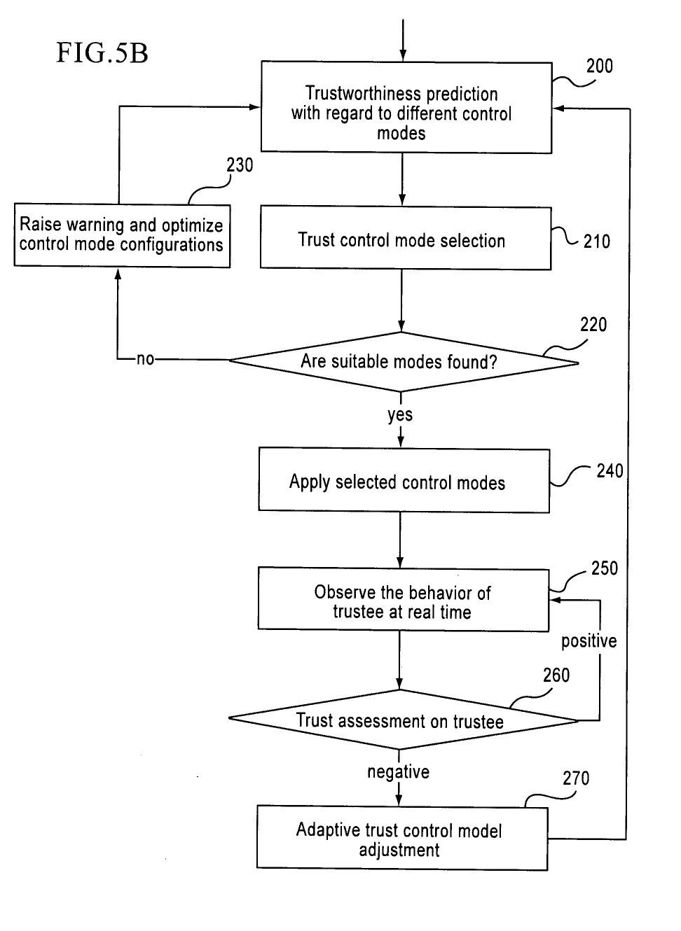

Trusted Platform Module (TPM) 10 illustrated in FIG. 1 is a hardware module that is currently deployed in many commercial desktop and laptop PCs, servers, etc. An objective of a TPM is to provide a hardware-based root of trust for a computing system. TPM provides various basic functions including: (i) cryptographic functions such as random number generation, key generation and encryption/decryption, (ii) SHA-1 based integrity measurement, (iii) internal storage for protecting keys and logged measurements, (iv) sealing and binding operations (a combination of encryption and hashing operations with/without being tied to the platform state), etc. From the TPM 10, integrity is ensured to a platform based trust management framework (with essential autonomic trust management supporting functions) 20, which is embedded into a trusted computing platform that contains an operating system (OS) and TPM software stack, etc. Integrity is also ensured between the trust management framework 20 and a platform based trust management framework 30. An autonomic trust management (to be described in a description associated with FIG. 5B) is executed between the platform based trust management framework 30 and a software middleware platform 40, such as Java virtual machine or a component software platform, software components 50, and applications 60.

Software (SW) may refer to a method, program instructions, and/or data adapted for execution by a processor. The SW may be stored using any type of computer-readable media or machine-readable media. Furthermore, the SW may be stored on the media as source code or object code. The SW also may be stored on the media as compressed and/or encrypted data. Also, SW may generically encompass any type of software, such as programs, applications, computer programs, application programs, system programs, machine programs, operating system software, middleware, firmware, software modules, routines, subroutines, method, procedures, functions, software interfaces, application program interfaces (API), instruction sets, computing code, computer code, code segments, computer code segments, words, values, symbols, or any combination thereof. The embodiments are not limited in this context.

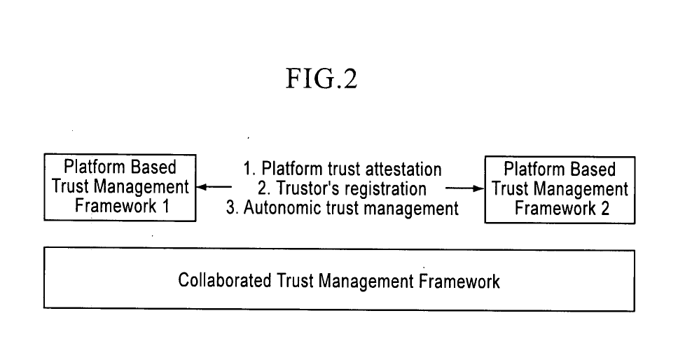

FIG. 2 illustrates a collaborated trust management framework, in accordance with an embodiment of the present invention. Specifically, the trust management framework may be implemented through collaboration among multiple platform based trust management frameworks through applying various mechanisms, such as a mechanism for sustaining trust among trusted computing platforms (TCPs) (platform based trust management framework 1 and platform based trust management framework 2). The mechanism builds up the trust relationship based on the root trust module (RTM) at a trustee and ensures the trust sustainability according to pre-defined conditions approved at the time of trust establishment and enforced through the use of the pre-attested RTM until the intended purpose is fulfilled. This mechanism may be suitable for a system that includes, for instance, a number of subsystems, such as, devices, that need remote communications in order to fulfill an intended purpose, such as, a GRID virtual organization or an e-commerce trading system. In this case, for a platform trust attestation, the trustor may be required to register at a remote platform based trust management framework. A trustor's registration is conducted on the basis of trust attestation of remote platform. In the autonomic trust management, the trustee's trustworthiness is managed (ensured or controlled) automatically through a collaborated trust management framework based on the trust criteria from the trustor. Particularly, it is flexible to deploy a hybrid trust management framework that applies both the platform trust management framework and the collaborated trust management framework.

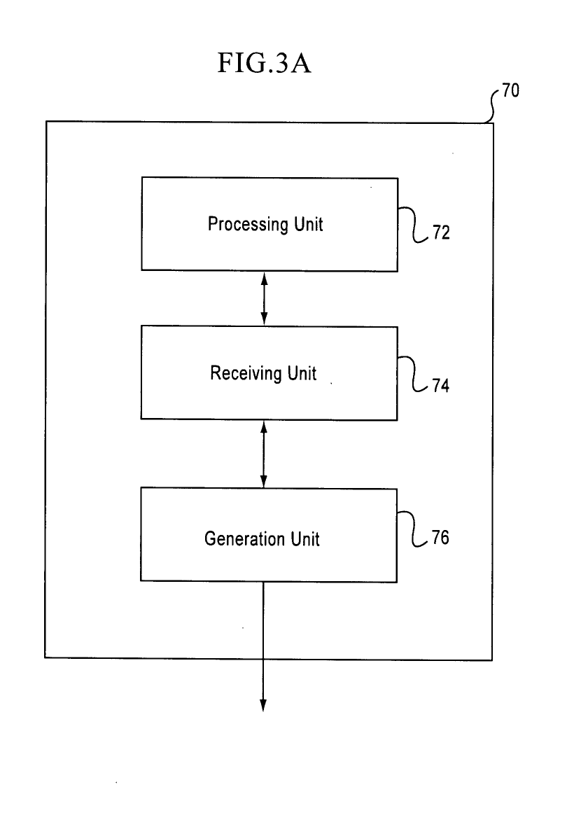

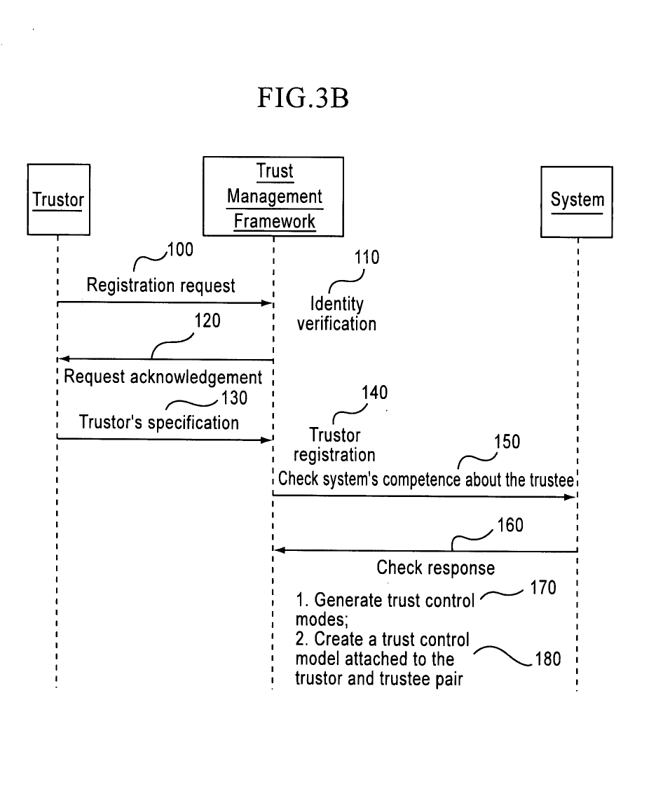

FIG. 3A illustrates a device 70 for a registration of a trustor at a trust management framework in a system, in accordance with an embodiment of the present invention. The device 70 includes a processing unit 72, a receiving unit 74, and a generation unit 76. The processing unit 72 is configured to receive a registration request from the trustor, perform a verification of an identification of the trustor, transmit a request acknowledgement to the trustor after verifying the trustor, receive a trustee identity and trust criteria regarding managing the trustworthiness of the trustee from the trustor, and determine whether the system comprises a competence to manage the trustee. The receiving unit 74 is configured to receive a confirmation from the system confirming the competence of the system to manage the trustee. The generation unit 76 is configured to generate, based on the competence, a number of different trust control modes to be applied by the system to manage the trustworthiness of the trustee and the trust control model attached to the underlying trustor and the trustee.

More particularly, FIG. 3B illustrates a procedure of a trustor's registration at a device of the trust management framework, in accordance with an embodiment of the present invention. The autonomic trust management is handled by the trust management framework (TMF). At step 100, the trustor entity transmits a registration request to the trust management framework. Upon receipt of the registration request, the trust management framework performs a verification of an identification of the trustor. In accordance with an exemplary embodiment, the trust management framework may compare an identifier of the trustor with a list or table of pre-stored identifiers to determine whether a match exists between the trustor identifier and any of the pre-stored identifiers. If the verification is positive, at step 120, the trust management framework transmits a request acknowledgement to the trustor. At step 130, the trustor sends a corresponding specification to the trust management framework, where the specification specifies a trustee identity and trust criteria regarding the trustee. The trust criteria may include, but it is not limited to, information regarding how to evaluate different quality attributes and a trust threshold. In accordance with an exemplary embodiment of the present invention, the trust threshold may be a value that indicates when the system needs to trigger trust control or re-establishment.

At step 140, the trust management framework verifies the format of the trustor's specification. At step 150, the trust management framework checks with the system to determine the system's competence for managing the trustee. The system competence may be defined as at least one mechanism or at least one operation supported by the system to ensure the trustworthiness of the trustee.

At step 160, the system transmits a response to the trust management framework confirming the system's competence to manage the trustworthiness of the trustee. Based on the competence, at step 170, the trust management framework generates a number of different trust control modes that may be applied by the system to manage the trustworthiness of the trustee. In one embodiment, control mechanisms or operations contained in the different trust control modes may be exclusive with each other. Furthermore, at step 180, the trust management framework creates a trust control model profile that may attach to, may be associated with, or may correspond to the trustor and the trustee pair.

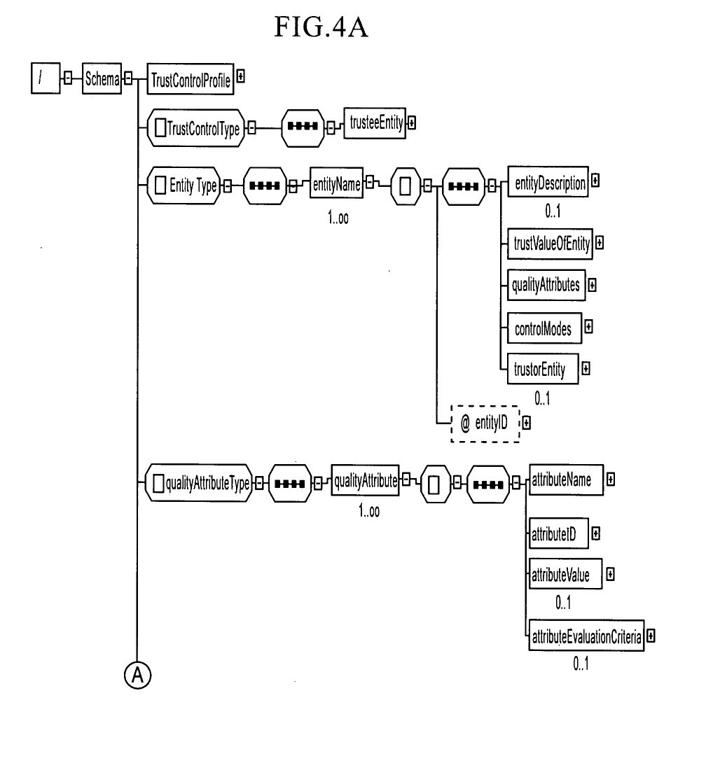

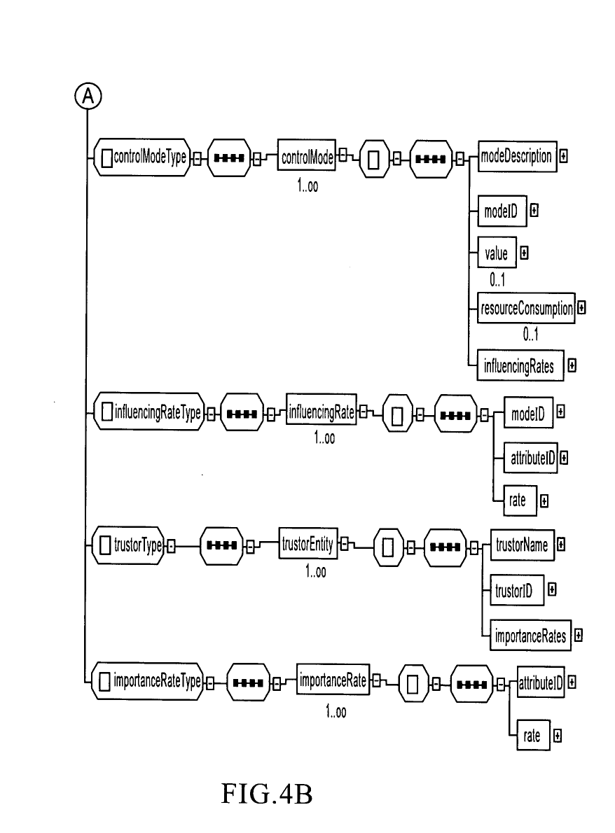

FIGS. 4A and 4B illustrate a data structure of trust control model profile, in accordance with an embodiment of the present invention. The profile of the trust control model may be described using extensible markup language (XML). The profile of the trust control model may contain information about trustor identity and trustee identity, quality attributes of the trustee and corresponding evaluation criteria, such as, importance rates of different criteria, criteria for setting positive and negative points regarding trust evaluation or assessment and some general criteria regarding multiple quality attributes. The profile of the trust control model may also contain information about trust control modes and corresponding initial influencing rates on different quality attributes, as well as a trust threshold. In accordance with an embodiment of the present invention, the profile of the trust control model may be dynamically maintained according to the real system context. For example, new control modes can be added and ineffective ones can be removed. The parameters of the profile (for instance, importance rates and influencing rates) may be adjusted based on the underlying trustor's criteria and the real system's performance, respectively. The trust management framework may conduct the trust management on the trustee based on this profile of the trust control model.

FIG. 5A illustrates a device 190 for a trust management framework to conduct autonomic trust management in a system targeting a trustee specified by a trustor, in accordance with an embodiment of the present invention. The device 190 includes a predicting unit 192, a selecting unit 194, and a determining unit 196. The predicting unit 192 is configured to predict the trustworthiness of the trustee by testing different trust control modes on the trustee and outputting a prediction result indicative thereof. The selecting unit 194 is configured to select a set of suitable trust control modes with an optimal trust value and optimal quality attribute values based on the prediction results. The determining unit 196 is configured to determine whether the system includes a trust control mode corresponding to the selected trust control modes and apply at the trustee the determined trust control modes by the system. An adaptation unit 198 monitors through the trust management framework the trustee's behavior in real time. The adaptation unit 198 conducts through the trust management framework a trust assessment based on newly collected data (mainly from observation). If the trust assessment is positive, the adaptation unit 198 continuous the observation and assessment of the trustee's trustworthiness. Otherwise, the adaptation unit 198 adjusts through the trust management framework a trust control model profile associated with the trustor and the trustee to perform autonomic trust management. Specifically, the parameters in the profile of the trust control model are adjusted or updated based on a real system situation and context.

More particularly, in accordance with an embodiment of the present invention, FIG. 5B illustrates a procedure to conduct autonomic trust management in a digital system (for instance, a device and a distributed system) targeting at a trustee entity specified by a trustor entity. At step 200, the trust management framework predicts the trustworthiness of the trustee by trying, sampling, or testing different compositions of various control modes and outputs a prediction result indicative thereof. The prediction of the trustworthiness of the trustee is a mechanism to anticipate the performance or feasibility of applying a set of trust control modes on the trustee before taking a concrete action. It is generally conducted through predicting the trust value of the trustee and its quality attributes' values supposed that the operations or mechanisms contained by a set of trust control modes are applied before the decision to initiate those control operations or mechanisms of the set of trust control modes is made. The set of trust control modes contains at least one trust control mode, in which at least one trust control operation or one trust control mechanism is included.

Based on the prediction result, at step 210, the trust management framework selects a set of optimal trust control modes with an optimal predicted trust value of the trustee and the optimal values of the trustee's quality attributes. The acceptable optimal values of trust and quality attributes may be above a threshold value, which may be the average predicted trust values of all possible compositions of trust control modes. Thus, the trust management framework verifies a format of the trustor's specification and checks with the system regarding the system's competence for managing the trustee. The system's competence may be measured by what types of mechanisms or operations that may be supported by the system to ensure the trustworthiness of the trustee,

At step 220, a determination is made by the trust management framework whether the system includes a trust control mode corresponding to the selected at least one trust control mode. Thus, based on the competence, the trust management framework generates a number of trust control modes that may be applied by the system to manage the trustworthiness of the trustee.

If there is no suitable trust control mode (for instance, the predicted trust value is too low), at step 230, the system outputs a warning indicative that the trust control mode configuration in the system needs to be optimized. After the trust management framework selects the optimal trust control mode, at step 240, the system applies the selected trust control modes. Thus, in accordance with an embodiment of the present invention, the trust control mode selection is a mechanism to select the most suitable trust control mechanisms based on the above prediction results in order to manage trust. For autonomic trust management in a digital system, the trust control mode prediction and selection are important functionalities with regard to the automatic processing of trust management.

Then, at step 250, the trust management framework monitors the trustee's behavior in real time. At step 260, the trust management framework conducts a trust assessment based on newly collected data (mainly from observation). If the trust assessment is positive, the procedure returns to step 250 to continue the observation and assessment. Otherwise, at step 270, the trust management framework conducts an adjustment on the trust control model. Specifically, the parameters in the profile of the trust control model are upgraded based on the real system situation and context. Then, the procedure will go back to the trustworthiness prediction at step 200. In accordance with an embodiment of the present invention, the trust assessment may be triggered when there are changes occurring in the system, for instance, a change that may influence or affect the trustee.

In view of the above, in accordance with an embodiment of the present invention, for a registered trustor, the trustworthiness of a corresponding specified trustee may be predicted regarding various control modes supported by the system. The control mode would include a number of control mechanisms or operations, for instance, encryption, authentication, hash code based integrity check, access control mechanisms, duplication of process, man in-middle solution for improving availability, etc. It can be treated as a special configuration of trust management that may be provided by the system. Based on the prediction results, a suitable set of control modes may be selected to establish the trust relationship between the trustor and the trustee. Furthermore, a runtime trust assessment mechanism may be triggered to evaluate the trustworthiness of the trustee through monitoring its behavior based on the instruction of the trustor's criteria.

According to the runtime trust assessment results, the system conducts a trust control model adjustment in order to reflect the real system context and situation if the assessed trustworthiness value is below an expected threshold. This threshold is generally set by the trustor to express the trustor's real expectation on the assessment. Then, the system repeats the procedure of trustworthiness prediction, control mode selection, and trust assessment, as well as, adaptive adjustment of the trust control model. Context-aware or situation-aware adaptability of the trust control model is important to re-select suitable control modes for the system to conduct autonomic trust management.

In accordance with an embodiment of the present invention, a computer program product embodied on a computer-readable medium may also be provided, encoding instructions for performing at least the method described in FIGS. 3B and 5B, in accordance with an embodiment of the present invention. The computer program product can be embodied on a computer readable medium. The computer program product can include encoded instructions for processing the trustor's registration at the trust management framework and the autonomic trust management, which may also be stored on the computer readable medium.

The computer program product can be implemented in hardware, software, or a hybrid implementation. The computer program product can be composed of modules that are in operative communication with one another, and which are designed to pass information or instructions to a communications device such as the mobile station or network node. The computer program product can be configured to operate on a general purpose computer or an application specific integrated circuit (ASIC).

A person of ordinary skill in the art will appreciate that some of the many advantages of the present invention include, at least, adaptability and robustness. In accordance with an adaptive benefit of the present invention, the trust control model may be dynamically maintained according to the real system context. For example, new control modes may be added and ineffective ones may be removed. The parameters of the trust control model may be adjusted based on a trust control model adjustment result. In accordance with a robustness benefit of the present invention, the trust control model may be adaptively adjusted based on a real system situation or context. Once there are some problems occurring that may influence the trustworthiness, the trust control model can be adaptively adjusted to reflect them. It will be obvious to know the performance or effectiveness of the applied control modes through the trust control model. It will be easier for the system to detect attacks or problems. Thereby, it is possible to re-select other trust control modes to re-establish or ensure the trustworthiness.

For example, when some malicious behaviors or attacks happen, the currently applied trust control modes may be found not feasible based on an established trust assessment. In this case, the influencing factors of the applied control modes should be adjusted in order to reflect the real system situation. Then, the system may automatically re-predict and re-select a set of new control modes in order to ensure the trustworthiness. In this way, the system can avoid using attacked or useless trust control mechanisms. A system user would be informed if there is no suitable selection of trust control modes. A person of ordinary skill in the art will appreciate that the robustness is also related to control mode configurations. The trust prediction and control mode selection mechanisms may further help the system optimizing the configurations of the trust control modes.

In addition, other advantages of the present invention include improving trust and security for mobile commerce systems and mobile networking. The various embodiments of the present invention may be used for trustworthiness management in a software platform, an electronic trading system, distributed systems and e-commerce systems (for instance, Ad Hoc Networks, Peer-to-Peer (P2P) systems and GRID computing systems, and e-transactions).

It is to be understood that, in the embodiment of the present invention, the steps described in FIGS. 3B and 5B may be performed in the sequence and manner as shown, although the order of some steps and the like may be changed without departing from the spirit and scope of the present invention. In addition, the steps described in FIGS. 3B and 5B may be repeated as many times as needed.

With respect to the present invention, a trustee may be a device, a mobile station or any other type of device that utilizes network data, and can include user equipment, a terminal, a network element, a switch, a router, a communication terminal, a bridge, a gateway or a server. In addition, while the term data has been used in the description of the present invention, the invention has import to many types of network data and system data. The data is about information to conduct trust assessment or evaluation aiming at autonomic trust management. The data includes any information related to the trustor's trust criteria and policies, trustor's experience, experience feedbacks; any information related to the trustee's performance, competence, behavior, reputations and so on; any information related to the system context, situation and environment.

Therefore, in accordance with an embodiment of the present invention, there is provided a device or a communication system applying a mechanism to manage trust relationships between any system entities in an autonomic way. The trust management may be processed by predicting trustworthiness based on control mechanisms applied, selecting suitable control mechanisms based on prediction results, assessing the trust worthiness according to the observation on trustee entity's behavior, and re-selecting trust control mechanisms or operations, if necessary, based on newly earned experience.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and step illustrated and described, and accordingly all suitable modifications and equivalents may be resorted to, falling within the scope of the invention.

1. A trust management method, comprising:
determining at a trust management framework whether a system comprises a competence to manage a trustee, wherein the competence comprises at least one trust control mode supported by the system to ensure a trustworthiness of the trustee;
based on the competence, generating a number of different trust control modes at the trust management framework to be applied by the system to manage the trustworthiness of the trustee and to provide an autonomic adaptation of the applied trust control modes to ensure a dynamic changed trust relationship; and
based on the trust control modes generated, generating and adjusting at the trust management framework at least one trust control model profile associated with the trustor and the trustee to perform autonomic trust management.

2. The trust management method as recited in claim 1, wherein the at least one trust control mode comprises at least one of encryption, authentication, hash code based integrity check, access control mechanisms, duplication of process, and man-in-middle solution for improving availability.

3. A trust management method, comprising:
receiving a trustee identity and trust criteria regarding a trustee from a trustor at a trust management framework;
determining at the trust management framework whether a system comprises a competence to manage the trustee;
transmitting a response from the system to the trust management framework confirming the competence of the system to manage the trustee;
based on the competence, generating a number of different trust control modes at the trust management framework to be applied by the system to manage a trustworthiness of the trustee; and
based on the trust control modes generated, creating at the trust management framework a trust control model profile associated with the trustor and the trustee to perform autonomic trust management.

4. The method as recited in independent claim 3, wherein prior to the receiving of the trustee identity, the method further comprising:
receiving a request from the trustor to a trust management framework to register the trustor at a trust management framework in the system;
performing a verification of an identification of the trustor with the trust management framework; and
transmitting a request acknowledgement from the trust management framework to the trustor after verifying the trustor.

5. The trust management method as recited in claim 3, further comprising:
configuring control mechanisms or operations that are exclusive and contained in the different trust control modes.

6. The trust management method as recited in claim 3, further comprising:
configuring the trustworthiness of the trustee to be based on subjective criteria of the trustor and quality attributes associated with the trustee, and influenced by context information, wherein context information comprises information to characterize a situation of the trustee and trustor, wherein the trustworthiness of the trustee is based on the quality attributes associated with the trustee, which comprise at least one of security, availability, reliability, and recommendations or reputations with regard to the trustee.

7. The trust management method as recited in claim 6, wherein the quality attributes are controlled or changed by applying a number of trust control mechanisms.

8. The trust management method as recited in claim 3, further comprising:
configuring the trust control model profile to use extensible markup language and to comprise information about trustor identity and trustee identity, quality attributes of the trustee and corresponding evaluation criteria including importance rates of different criteria, criteria for setting positive and negative points regarding trust evaluation or assessment, and criteria regarding multiple quality attributes.

9. The trust management method as recited in claim 8, further comprising:
configuring the trust control model profile to further comprises information about the trust control modes and corresponding initial influencing rates on different quality attributes of the trustee, and a trust threshold.

10. The trust management method as recited in claim 3, wherein the competence comprises at least one mechanism or at least one operation supported by the system to ensure the trustworthiness of the trustee.

11. The trust management method as recited in claim 10, wherein the trustworthiness of the trustee is based on quality attributes associated with the trustee, which comprise at least one of security, availability, reliability, recommendations, and reputations of the trustee.

12. The trust management method as recited in claim 3, further comprising:
configuring the trust criteria to comprise information on how to evaluate different quality attributes and a trust threshold, which comprises a value that indicates when trust control or re-establishment is to be triggered.

13. The trust management method as recited in claim 3, further comprising:
dynamically maintaining the trust control model profile according to a real system context.

14. The trust management method as recited in claim 3, wherein the trust management of the trustee is based on the trust control model profile.

15. A trust management method, comprising:
predicting a trustworthiness of a trustee specified by a trustor at a trust management framework by testing different trust control modes on a trustee and outputting prediction results indicative thereof;
selecting a set of trust control modes by the trust management framework with an optimal trust value and optimal quality attribute values to manage the trustee based on the prediction results;
determining whether a system includes a trust control mode corresponding to the selected trust control modes;
applying at the trustee the determined trust control modes by the system;
monitoring through the trust management framework a behavior of the trustee in real time to collect data;
executing through the trust management framework a trust assessment based on the collected data;
when the trust assessment is positive, continuing the monitoring of the behavior of the trustee; and
when the trust assessment is negative, adjusting through the trust management framework a trust control model profile associated with the trustor and the trustee to perform autonomic trust management.

16. The trust management method as recited in claim 15, wherein each of the trust control modes comprises at least one trust control mechanism or operation that could be encryption, authentication, hash code based integrity check, access control mechanisms, duplication of process, and man-in-middle solution.

17. The trust management method as recited in claim 15, wherein the prediction of the trustworthiness of the trustee comprises:
anticipating a performance or feasibility of applying a trust control mechanism on the trustee before taking an action, and
predicting a trust value for the trustee supposed that the trust control mode to be applied before the decision to initiate the trust control mode on the trustee is made, wherein the trust control mode comprises at least one of encryption, authentication, hash code based integrity check, access control mechanisms, duplication of process, and man-in-middle solution.

18. The trust management method as recited in claim 15, wherein, when the determination indicates that there is no trust control mode in the system corresponding to the selected trust control mode, the method further comprises:
outputting a warning indicative that the trust control mode configuration in the system needs to be optimized.

19. The trust management method as recited in claim 15, wherein the method is triggered when there are changes occurring in the system.

20. The trust management method as recited in claim 15, further comprising:
monitoring the behavior or performance of the trustee in real time by the trust management framework to collect data for trust assessment or evaluation;
performing a trust assessment based on the collected data by the trust management framework;
when the trust assessment is positive, continuing monitoring of the trustee's behavior; and
when the trust assessment is negative, performing an adjustment on the determined trust control mode by the trust management framework.

21. A device for trust management, comprising:
a determining unit configured to determine whether a system comprises a competence to manage a trustee, wherein the competence comprises at least one trust control mode supported by the system to ensure a trustworthiness of the trustee; and
a generating unit
configured to generate, based on the competence, a number of different trust control modes at the trust management framework to be applied by the system to manage the trustworthiness of the trustee and to provide an autonomic adaptation of the applied trust control modes to ensure a dynamic changed trust relationship, and
based on the trust control modes generated, configured to generate and adjust at the trust management framework at least one trust control model profile associated with a trustor and the trustee to perform autonomic trust management.

22. The device as recited in claim 21, wherein the trustor comprises a system user, a device user, a component, a composition of component, a sub-system inside a system or the device, part of the system or the device, the system, or the device.

23. The device as recited in claim 21, wherein the trustee comprises a system user, a device user, a component, a composition of component, a sub-system inside a system or the device, part of the system or the device, the system, or the device.

24. The device as recited in claim 21, wherein the at least one trust control mode comprises at least one of encryption, authentication, hash code based integrity check, access control mechanisms, duplication of process, and man-in-middle solution for improving availability.

25. A device, comprising:
a processing unit configured to
receive a request from a trustor to register the trustor at a trust management framework in a system,
perform a verification of an identification of the trustor,
transmit a request acknowledgement to the trustor after verifying the trustor,
receive a trustee identity and trust criteria regarding a trustee from the trustor, and
determine whether the system comprises a competence to manage the trustee;
a receiving unit configured to receive a confirmation from the system confirming the competence of the system to manage the trustee; and
a generation unit configured to generate, based on the competence, a number of different trust control modes at the trust management framework to be applied by the system to manage a trustworthiness of the trustee, and configured to create, based on the trust control modes generated, at the trust management framework a trust control model profile associated with the trustor and the trustee to perform autonomic trust management.

26. The device as recited in claim 25, wherein control mechanisms or operations contained in the different trust control modes are configured to be exclusive with each other.

27. The device as recited in claim 25, wherein the trustworthiness of the trustee is based on subjective criteria of the trustor and quality attributes associated with the trustee, and influenced by context information, wherein context information comprises information to characterize a situation of the trustee and trustor, wherein the trustworthiness of the trustee is based on the quality attributes associated with the trustee, which comprise at least one of security, availability, reliability, and recommendations or reputations with regard to the trustee.

28. The device as recited in claim 27, wherein the quality attributes are controlled or changed by applying a number of trust control mechanisms.

29. The device as recited in claim 25, wherein the trust control model profile is configured to use extensible markup language and to comprise information about trustor identity and trustee identity, quality attributes of the trustee and corresponding evaluation criteria including importance rates of different criteria, criteria for setting positive and negative points regarding trust evaluation or assessment, and criteria regarding multiple quality attributes.

30. The device as recited in claim 25, wherein the trust control model profile further comprises information about the trust control modes and corresponding initial influencing rates on different quality attributes of the trustee, and a trust threshold.

31. The device as recited in claim 25, wherein the competence comprises at least one mechanism or at least one operation supported by the system to ensure the trustworthiness of the trustee.

32. The device as recited in claim 31, wherein the trustworthiness of the trustee is based on quality attributes associated with the trustee, wherein the quality attributes comprise at least one of security, availability, reliability, recommendations, and reputations of the trustee.

33. The device as recited in claim 25, wherein the trust criteria comprises information on how to evaluate different quality attributes and a trust threshold, which comprises a value that indicates when trust control or re-establishment is to be triggered.

34. The device as recited in claim 25, wherein the trust control model profile is dynamically maintained according to a real system context.

35. The device as recited in claim 25, wherein the trust management of the trustee is based on the trust control model profile.

36. The device as recited in claim 25, wherein the device comprises a mobile station, a user equipment, a terminal, a network element, a switch, a router, a communication terminal, a bridge, a gateway or a server.

37. The device as recited in claim 25, wherein the trustor comprises a system user, a device user, a component, a composition of component, a sub-system inside a system or the device, part of the system or the device, the system, or the device.

38. The device as recited in claim 25, wherein the trustee comprises a system user, a device user, a component, a composition of component, a sub-system inside a system or the device, part of the system or the device, the system, or the device.

39. A device, comprising:
a predicting unit configured to predict a trustworthiness of a trustee specified by a trustor at a trust management framework by testing different trust control modes on the trustee and outputting prediction results indicative thereof;
a selecting unit configured to select a set of suitable trust control modes with an optimal trust value and optimal quality attribute values based on the prediction results;
a determining unit configured to determine whether a system includes a trust control mode corresponding to the selected trust control modes and apply at the trustee the determined trust control modes by the system; and
an adaptation unit configured to monitor through the trust management framework a behavior of the trustee in real time to collect data, and to execute through the trust management framework a trust assessment based on the collected data, wherein when the trust assessment is positive, the adaptation unit is configured to continue the monitoring of the behavior of the trustee, and when the trust assessment is negative, the adaptation unit is configured to adjust through the trust management framework a trust control model profile associated with the trustor and the trustee to perform autonomic trust management.

40. The device as recited in claim 39, wherein each of the trust control modes comprises at least a trust control mechanism or operation that could be encryption, authentication, hash code based integrity check, access control mechanisms, duplication of process, and man-in-middle solution.

41. The device as recited in claim 39, wherein the predicting unit is configured to predict the trustworthiness of the trustee by anticipating a performance or feasibility of applying a set of trust control modes on the trustee before taking action, and predicting a trust value for the trustee supposed that the set of trust control modes to be applied before the decision to initiate the trust control modes on the trustee is made, wherein the trust control mode comprises at least one of encryption, authentication, hash code based integrity check, access control mechanisms, duplication of process, and man-in-middle solution.

42. The device as recited in claim 39, wherein, when the determining unit determines that there is no trust control mode in the system corresponding to the selected trust control mode, a warning is output indicative that the trust control mode configuration in the system needs to be optimized.

43. The device as recited in claim 39, wherein the prediction is triggered when there are changes occurring in the system.

44. The device as recited in claim 39, wherein the trustworthiness of the trustee is monitored in real time.

45. The device as recited in claim 39, wherein the device comprises a mobile station, a user equipment, a terminal, a network element, a switch, a router, a communication terminal, a bridge, a gateway or a server.

46. The device as recited in claim 39, wherein the trustor comprises a system user, a device user, a component, a composition of component, a sub-system inside a system or the device, part of the system or the device, the system, or the device.

47. The device as recited in claim 39, wherein the trustee comprises a system user, a device user, a component, a composition of component, a sub-system inside a system or the device, part of the system or the device, the system, or the device.

48. A device for trust management, comprising:
determining means for determining whether a system comprises a competence to manage a trustee, wherein the competence comprises at least one trust control mode supported by the system to ensure a trustworthiness of the trustee; and
generating means for
generating, based on the competence, a number of different trust control modes at the trust management framework to be applied by the system to manage the trustworthiness of the trustee and to provide an autonomic adaptation of the applied trust control modes to ensure a dynamic changed trust relationship, and based on the trust control modes generated, generating and adjusting at the trust management framework at least one trust control model profile associated with a trustor and the trustee to perform autonomic trust management.

49. A device, comprising:
processing means for
receiving a request from a trustor to register the trustor at a trust management framework in a system,
performing a verification of an identification of the trustor,
transmitting a request acknowledgement to the trustor after verifying the trustor,
receiving a trustee identity and trust criteria regarding a trustee from the trustor, and
determining whether the system comprises a competence to manage the trustee;
receiving means for receiving a confirmation from the system confirming the competence of the system to manage the trustee; and
generation means for generating, based on the competence, a number of different trust control modes at the trust management framework to be applied by the system to manage a trustworthiness of the trustee, and for creating, based on the trust control modes generated, at the trust management framework a trust control model profile associated with the trustor and the trustee to perform autonomic trust management.

50. A device, comprising:
predicting unit means for predicting a trustworthiness of a trustee specified by a trustor at a trust management framework by testing different trust control modes on the trustee and outputting prediction results indicative thereof;
selecting means for selecting a set of suitable trust control mode with an optimal trust value and optimal quality attribute values based on the prediction results;
determining means for determining whether a system includes a trust control mode corresponding to the selected trust control modes and apply at the trustee the determined trust control modes by the system; and
adaptation means for monitoring through the trust management framework a behavior of the trustee in real time to collect data, and for executing through the trust management framework a trust assessment based on the collected data, wherein when the trust assessment is positive, the adaptation means continues the monitoring of the behavior of the trustee, and when the trust assessment is negative, the adaptation means adjusts through the trust management framework a trust control model profile associated with the trustor and the trustee to perform autonomic trust management.

51. An autonomic trust management system for autonomic trust management, comprising:
a determining unit configured to determine whether the system comprises a competence to manage a trustee, wherein the competence comprises at least one trust control mode supported by the system to ensure a trustworthiness of the trustee; and
a generating unit
configured to generate, based on the competence, a number of different trust control modes at the trust management framework to be applied by the system to manage the trustworthiness of the trustee and to provide an autonomic adaptation of the applied trust control modes to ensure a dynamic changed trust relationship, and
based on the trust control modes generated, configured to generate and adjust at the trust management framework at least one trust control model profile associated with the trustor and the trustee to perform the autonomic trust management.

52. An autonomic trust management system for autonomic trust management, comprising:
a processing unit configured to
receive a request from a trustor to register the trustor at a trust management framework in the system,
perform a verification of an identification of the trustor,
transmit a request acknowledgement to the trustor after verifying the trustor,
receive a trustee identity and trust criteria regarding a trustee from the trustor, and
determine whether the system comprises a competence to manage the trustee;
a receiving unit configured to receive a confirmation from the system confirming the competence of the system to manage the trustee; and
a generation unit configured to generate, based on the competence, a number of different trust control modes at the trust management framework to be applied by the system to manage a trustworthiness of the trustee, and configured to create, based on the trust control modes generated, at the trust management framework a trust control model profile associated with the trustor and the trustee to perform the autonomic trust management.

53. An autonomic trust management system for autonomic trust management, comprising:
a predicting unit configured to predict a trustworthiness of a trustee specified by a trustor at a trust management framework by testing different trust control modes on the trustee and outputting prediction results indicative thereof;
a selecting unit configured to select a set of suitable trust control modes with an optimal trust value and optimal quality attribute values based on the prediction results;
a determining unit configured to determine whether the system includes a trust control mode corresponding to the selected trust control modes and apply at the trustee the determined trust control modes by the system; and
an adaptation unit configured to monitor through the trust management framework a behavior of the trustee in real time to collect data, and to execute through the trust management framework a trust assessment based on the collected data, wherein when the trust assessment is positive, the adaptation unit is configured to continue the monitoring of the behavior of the trustee, and when the trust assessment is negative, the adaptation unit is configured to adjust through the trust management framework a trust control model profile associated with the trustor and the trustee to perform the autonomic trust management.
